(19) United States
(12) Patent Application Publication
(10) Pub. No.: US 2019/0363399 A1
(43) Pub. Date: Nov. 28, 2019

(54) POWER STORAGE SHEET AND BATTERY

(71) Applicant: Murata Manufacturing Co., Ltd., Nagaokakyo-shi (JP)

(72) Inventors: Makoto Yoshioka, Nagaokakyo-shi (JP); Masahiko Kondo, Nagaokakyo-shi (JP)

(21) Appl. No.: 16/535,378

(22) Filed: Aug. 8, 2019

Related U.S. Application Data
(63) Continuation of application No. PCT/JP2017/044557, filed on Dec. 12, 2017.

(30) Foreign Application Priority Data
Feb. 23, 2017 (JP) 2017-031847

(51) Int. Cl. H01M 10/0562; H01M 10/04; H01M 10/0585; H01M 2/10; H01M 2/22; H01M 2/30

(52) U.S. Cl. CPC H01M 10/0562; H01M 10/04; H01M 10/0585; H01M 2300/0065; H01M 2/22; H01M 2/30; H01M 2/1077

(57) ABSTRACT

A power storage sheet that includes a plurality of all-solid-state power storage elements and a conductive member. The plurality of all-solid-state power storage elements are disposed in the same plane. The all-solid-state power storage element has a first external electrode on one side surface and a second external electrode on the other side surface. The conductive member is disposed between adjacent elements of the all-solid-state power storage elements. The conductive member fixes and electrically connects the side surfaces of the adjacent all-solid-state power storage elements to each other.

### CROSS REFERENCE TO RELATED APPLICATIONS

The present application is a continuation of International application No. PCT/JP2017/044557, filed Dec. 12, 2017, which claims priority to Japanese Patent Application No. 2017-031847, filed Feb. 23, 2017, the entire contents of each of which are incorporated herein by reference.

### FIELD OF THE INVENTION

The present invention relates to a power storage sheet and a battery including the power storage sheet.

### BACKGROUND OF THE INVENTION

Patent Document 1 describes a sheet-shaped power storage device including a flexible substrate, a positive electrode lead and a negative electrode lead provided on the substrate, and a plurality of power storage elements mounted on the substrate.

Patent Document 1: Japanese Patent Application Laid-Open No. 2016-207577

### SUMMARY OF THE INVENTION

There is a demand for the power storage sheet to increase the capacity per unit volume.

A main object of the present invention is to provide a power storage sheet which has a large capacity per unit volume.

A power storage sheet according to the present invention includes a plurality of all-solid-state power storage elements and a conductive member. The plurality of all-solid-state power storage elements are disposed in the same plane. The all-solid-state power storage element has a first external electrode provided on one side surface and a second external electrode provided on the other side surface. The conductive member is disposed between the all-solid-state power storage elements adjacent to each other. The conductive member fixes and electrically connects the side surfaces of adjacent elements of the all-solid-state power storage elements to each other.

In the power storage sheet according to the present invention, the first and second external electrodes are provided on the side surfaces of the all-solid-state power storage element, and the side surfaces of the all-solid-state power storage elements adjacent to each other are electrically connected to each other by the conductive member. For this reason, unlike the power storage device described in Patent Document 1, it is not always necessary to provide a sheet or a wiring for electrically connecting the all-solid-state power storage elements to each other, in the thickness direction with respect to the all-solid-state power storage elements. Thus, the power storage sheet can be reduced in thickness. Accordingly, the capacity of the power storage sheet per unit volume can be increased.

The power storage sheet according to the present invention may include another plurality of all-solid-state power storage elements connected in parallel to the other plurality of all-solid-state power storage elements.

The power storage sheet according to the present invention may include another plurality of all-solid-state power storage elements connected in series to the other plurality of all-solid-state power storage elements.

In the power storage sheet according to the present invention, the longest side of the all-solid-state power storage element is preferably 0.1 mm to 1 mm in length.

In the power storage sheet according to the present invention, the plurality of all-solid-state power storage elements may include a plurality of types of all-solid-state power storage elements that differ in capacity from each other.

In the power storage sheet according to the present invention, the plurality of all-solid-state power storage elements may include a plurality of types of all-solid-state power storage elements that differ from each other in area in a planar view of the power storage sheet.

The power storage sheet according to the present invention may include a plurality of all-solid-state power storage element layers that each include a plurality of all-solid-state power storage elements arranged in a matrix in a first direction and a second direction different from the first direction. In such a case, the plurality of all-solid-state power storage element layers may be stacked.

The power storage sheet according to the present invention may further include a fixing member that fixes the all-solid-state power storage elements adjacent to each other which are not fixed by the conductive member.

A battery according to an aspect of the present invention includes the power storage sheet described herein, and an exterior body housing the power storage sheet.

According to the present invention, a power storage sheet can be provided which has a large capacity per unit volume.

### BRIEF EXPLANATION OF THE DRAWINGS

FIG. 1 is a schematic plan view of a battery according to a first embodiment.

FIG. 2 is a schematic sectional view of an all-solid-state power storage element according to the first embodiment.

FIG. 3 is a schematic plan view of a battery according to a second embodiment.

FIG. 4 is a schematic plan view of a battery according to a third embodiment.

FIG. 5 is a schematic plan view of a battery according to a fourth embodiment.

FIG. 6 is a schematic plan view of a battery according to a fifth embodiment.

FIG. 7 is a schematic plan view of a battery according to a sixth embodiment.

### DETAILED DESCRIPTION OF THE INVENTION

An example of a preferred embodiment of the present invention will be described below. However, the following embodiment is considered by way of example only. The present invention is not limited to the following embodiment in any way.

In addition, members that have substantially the same functions shall be denoted by the same reference symbols in the respective drawings referred to in the embodiment and the like. In addition, the drawings referenced in the embodiment and the like are schematically made. The ratios between the dimensions of objects drawn in the drawings, and the like may, in some cases, differ from the ratios between the dimensions of actual objects, or the like. The dimensional ratios of objects, and the like may differ between the drawings as well in some cases. The specific dimensional ratios of objects, and the like should be determined in view of the following description.

It is to be noted that although a conductive member 21 is hatched in FIGS. 1 and 3 to 6, the hatching is not intended to represent the cross section of the conductive member 21.

### First Embodiment

FIG. 1 is a schematic plan view of a battery according to the first embodiment. The battery 2 shown in FIG. 1 may be a primary battery or a secondary battery.

The battery 2 includes a power storage sheet 1 and an exterior body 3.

The power storage sheet 1 includes a plurality of all-solid-state power storage elements 10. The all-solid-state power storage element 10 is a power storage element which has constituent elements all made of solid materials.

The plurality of all-solid-state power storage elements 10 are disposed in the same plane. Specifically, according to the present embodiment, the plurality of all-solid-state power storage elements 10 are arranged in a matrix in the x-axis direction and the y-axis direction. It is to be noted that an example in which the x-axis direction and the y-axis direction are orthogonal to each other will be described in the present embodiment. However, in the present invention, the plurality of all-solid-state power storage elements may be arranged in a matrix in a first direction and a second direction inclined with respect to the first direction.

The shape of the all-solid-state power storage element 10 is not particularly limited as long as the element has a shape with at least two side surfaces. Specifically, according to the present embodiment, the all-solid-state power storage element 10 has a cuboid shape.

It is to be noted that according to the present invention, the “cuboid shape” is considered including a cuboid shape with a corner or a ridge chamfered or rounded.

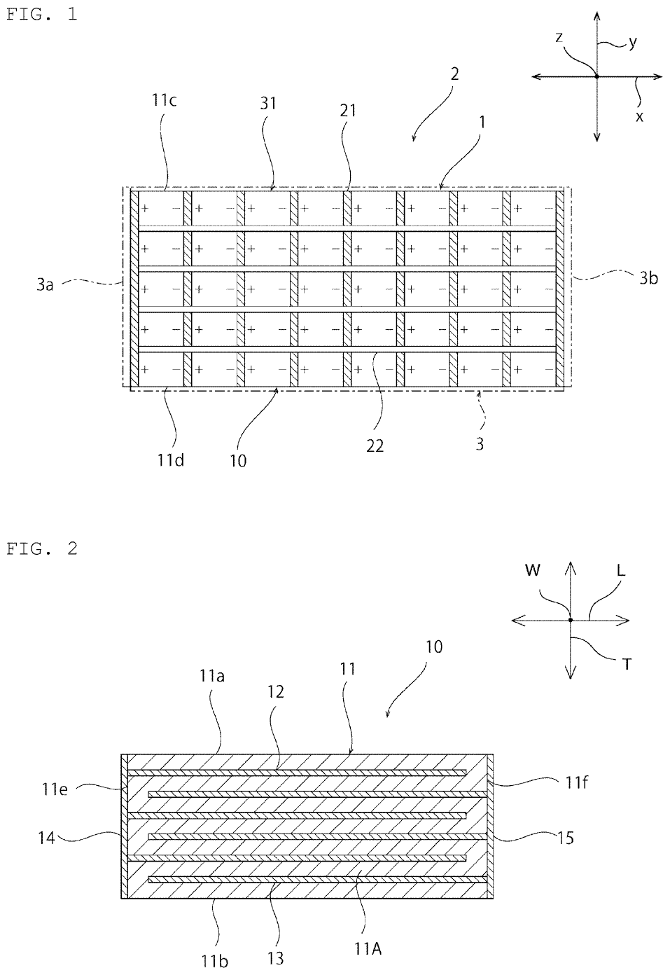

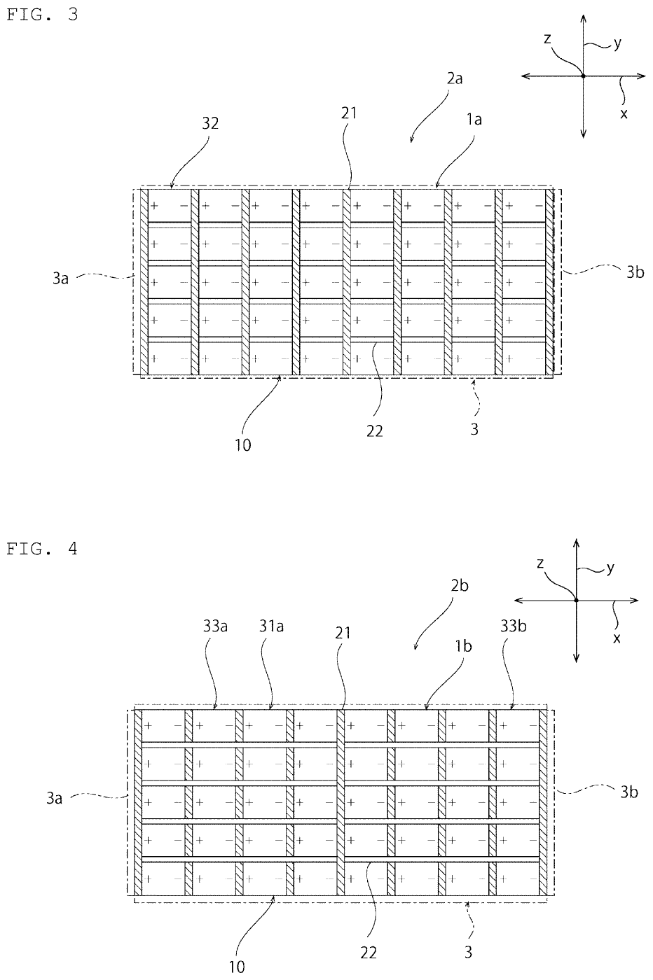

FIG. 2 is a schematic sectional view of the all-solid-state power storage element according to the first embodiment. The all-solid-state power storage element 10 includes an all-solid-state power storage element body 11. The all-solid-state power storage element body 11 has first and second main surfaces 11a, 11b extending in the length direction L and the width direction W, and first and second side surfaces 11c,11d (see FIG. 1) extending in the length direction L and the thickness direction T, and third and fourth side surfaces 11e, 11f extending in the width direction W and the thickness direction T.

Inside the all-solid-state power storage element body 11, a plurality of first internal electrodes 12 and a plurality of second internal electrodes 13 are provided.

The plurality of first internal electrodes 12 are each provided in parallel with the first and second main surfaces 11a and 11b. The plurality of first internal electrodes 12 are each extended to the third side surface 11e, but not extended to the fourth side surface 11f. The plurality of first internal electrodes 12 are each connected to a first external electrode 14 provided on the third side surface 11e.

The plurality of second internal electrodes 13 are each provided in parallel with the first and second main surfaces 11a and 11b. The plurality of second internal electrodes 13 are each extended to the fourth side surface 11f, but not extended to the third side surface 11e. The plurality of second internal electrodes 13 are each connected to a second external electrode 15 provided on the fourth side surface 11f. One of the second external electrode 15 and the first external electrode 14 constitutes a positive electrode, and the other constitutes a negative electrode. Hereinafter, in the present embodiment, an example in which the first external electrode 14 constitutes a positive electrode and the second external electrode 15 constitutes a negative electrode will be described.

The plurality of first internal electrodes 12 and the plurality of second internal electrodes 13 are alternately arranged at mutual intervals in the thickness direction T. A part of the all-solid-state power storage element body 11 located between the first internal electrode 12 and the second internal electrode 13 adjacent in the thickness direction T constitutes a solid electrolyte layer 11A.

The first internal electrode 12 connected to the first external electrode 14 constituting a positive electrode is composed of a sintered body including positive electrode active material particles, solid electrolyte particles, and conductive particles. Specific examples of the positive electrode active material preferably used include lithium-containing phosphate compounds which have a NASICON-type structure, lithium-containing phosphate compounds which have an olivine-type structure, lithium-containing layered oxides, and lithium-containing oxides which have a spinel-type structure. Specific examples of the preferably used lithium-containing phosphate compounds which have a NASICON-type structure include Li₃V₂(PO₄)₃. Specific examples of the preferably used lithium-containing phosphate compounds which have an olivine-type structure include LiFePO₄, LiMnPO₄, and LiCoPO₄. Specific examples of the preferably used lithium-containing layered oxides include LiCoO₂ and LiCo_{1/3}Ni_{1/3}Mh_{1/3}O₂. Specific examples of the preferably used lithium-containing oxides which have a spinel-type structure include LiMn₂O₄ and LiNi_{0.5}Mn_{1.5}O₄. Only one of these positive electrode active materials may be used, or two or more thereof may be used in mixture.

Examples preferably used as the solid electrolyte included in the positive electrode active material layer include lithium-containing phosphate compounds which have a NASICON structure, oxide solid electrolytes which have a perovskite structure, and oxide solid electrolytes which have a garnet-type or garnet-type similar structure. The preferably used lithium-containing phosphate compounds which have a NASICON structure include LiₓM_{y}(PO₄)₃ (0.9x≤1.9, 1.9≤y≤2.1, M represents at least one selected from the group consisting of Ti, Ge, Al, Ga, and Zr). Specific examples of the preferably used lithium-containing phosphate compounds which have a NASICON structure include Li_{1.4}Al_{0.4}Ge_{1.6}(PO₄)₃ and Li_{1.2}Al_{0.2}Ti_{1.8}(PO₄)₃. Specific examples of the preferably used oxide solid electrolytes which have a perovskite structure include La_{0.55}Li_{0.35}TiO₃. Specific examples of the preferably used oxide solid electrolytes which have a garnet-type or garnet-type similar structure include Li₇La₃Zr₂O₁₂. Only one of these solid electrolytes may be used, or two or more thereof may be used in mixture.

Examples preferably used as the conductive particles included in the positive electrode active material layer can be made of a metal such as Ag, Au, Pt, and Pd, carbon, a compound with electron conductivity, a mixture of a combination thereof, or the like. In addition, these conductive substance may be included in a form that covers the surfaces of positive electrode active material particles or the like.

The second internal electrode 13 connected to the second external electrode 15 constituting a negative electrode is composed of a sintered body including negative electrode active material particles, solid electrolyte particles, and conductive particles. Specific examples of the negative electrode active material preferably used include compounds represented by MOx (M represents at least one selected from the group consisting of Ti, Si, Sn, Cr, Fe, Nb, V, and Mo, 0.9≤X≤3.0), graphite-lithium compounds, lithium alloys, lithium-containing phosphate compounds which have a NASICON-type structure, lithium-containing phosphate compounds which have an olivine-type structure, and lithium-containing oxides which have a spinel-type structure. It is to be noted the oxygen of the compound represented by MOx may be partially substituted with P or Si. Further, compounds can also be suitably used which are represented by LiyMOₓ (M represents at least one selected from the group consisting of Ti, Si, Sn, Cr, Fe, Nb, V, and Mo, 0.9≤X≤3.0, 2.0≤Y≤4.0). Specific examples of the preferably used lithium alloys include Li—Al. Specific examples of the preferably used lithium-containing phosphate compounds which have a NASICON-type structure include Li₃V₂(PO₄)₃. Specific examples of the preferably used lithium-containing phosphate compounds which have an olivine-type structure include LiCu(PO₄). Specific examples of the preferably used lithium-containing oxides which have a spinel-type structure include Li₄Ti₅O₁₂. Only one of these negative electrode active materials may be used, or two or more thereof may be used in mixture.

Specific examples of the preferably used solid electrolyte can include the same electrolytes as those preferably used as the solid electrolyte included in the first internal electrode 12 described above.

Specific examples of the preferably used conductive particles can include the same conductive particles as those preferably used as the conductive particles included in the first internal electrode 12 described above.

The all-solid-state power storage element body 11 constituting the solid electrolyte layer 11A is composed of a sintered body of solid electrolyte particles. Specific examples of the preferably used solid electrolyte include lithium-containing phosphate compounds which have a NASICON structure, oxide solid electrolytes which have a perovskite structure, and oxide solid electrolytes which have a garnet-type or garnet-type similar structure. The preferably used lithium-containing phosphate compounds which have a NASICON structure include LiₓM_{y}(PO₄)₃ (1×2, 1≤y≤2, M represents at least one selected from the group consisting of Ti, Ge, Al, Ga, and Zr). Specific examples of the preferably used lithium-containing phosphate compounds which have a NASICON structure include Li_{1.2}Al_{0.2}Ti_{1.8}(PO₄)₃. Specific examples of the preferably used oxide solid electrolytes which have a perovskite structure include La_{0.55}Li_{0.35}TiO₃. Specific examples of the preferably used oxide solid electrolytes which have a garnet-type or garnet-type similar structure include Li₇La₃Zr₂O₁₂. Only one of these solid electrolytes may be used, or two or more thereof may be used in mixture.

The first and second external electrodes 14, 15 may be each made of, for example, carbon, a compound with electron conductivity, a mixture of a combination thereof, or the like, and also metals such as Ni, Al, Sn, Cu, Ag, Au, Pt, and Pd.

In the all-solid-state power storage element 10, at least the first and second internal electrodes 12, 13 and the all-solid-state power storage element body 11 are integrally sintered. In other words, the all-solid-state power storage element 10 is an integrally sintered body of at least the first and second internal electrodes 12 and 13 and the all-solid-state power storage element body 11. The first and second external electrodes 14, 15 may be sintered integrally with the first and second internal electrodes 12, 13 and the all-solid-state power storage element body 11, or provided separately.

As shown in FIG. 1, the power storage sheet 1 has the conductive member 21 disposed between the all-solid-state power storage elements 10 adjacent to each other. The conductive member 21 fixes and electrically connects the all-solid-state power storage elements 10 adjacent to each other. More specifically, the conductive member 21 electrically connects the first external electrode 14 provided on the side surface of one of the all-solid-state power storage elements 10 adjacent to each other to the second external electrode 15 provided on the other side surface.

Specifically, according to the present embodiment, the all-solid-state power storage elements 10 adjacent to each other in the x-axis direction are fixed and electrically connected to each other by the conductive member 21. Thus, the plurality of all-solid-state power storage elements 10 arranged in the x-axis direction are connected in series. In the power storage sheet 1, the plurality of all-solid-state power storage element rows 31 connected in series are provided in the y-axis direction.

It is to be noted that the conductive member 21 is not particularly limited, as long as the conductive member 21 can fix all and electrically connect all-solid-state power storage elements 10 to each other. The conductive member 21 can be composed of, for example, a metal, a conductive adhesive material, a cured product of a conductive adhesive material, and the like. Specifically, for example, the conductive member 21 may be composed of: a metal foil; and a conductive adhesive material or a cured product of a conductive adhesive material provided on both sides of the metal foil.

In the power storage sheet 1, the all-solid-state power storage elements 10 adjacent to each other in the y-axis direction are not fixed by the conductive member 21. The all-solid-state power storage elements 10 adjacent to each other in the y-axis direction are fixed by a non-conductive fixing member 22. The fixing member 22 and the conductive member 21 fix all of the all-solid-state power storage elements 10, thereby forming the power storage sheet 1. Providing the fixing member 22 can improve the mechanical durability, impact resistance, and the like of the power storage sheet 1.

The fixing member 22 is not particularly limited, as long as the fixing member 22 can fix the all-solid-state power storage elements 10 adjacent to each other. The fixing member 22 can be made of, for example, a non-conductive adhesive material or a cured product of a non-conductive adhesive material, or the like. Specifically, the fixing member 22 can be made of, for example, an organic substance such as a resin, an elastomer, or paper, an inorganic substance such as glass, or the like.

It is to be noted that the power storage sheet 1 may be a flexible body with flexibility or a rigid body without flexibility.

The power storage sheet 1 is housed in the exterior body 3. The exterior body 3 has a first terminal (positive electrode terminal) 3a and a second terminal (negative electrode terminal) 3b. According to the present embodiment, each positive electrode side of the plurality of all-solid-state power storage element rows 31 of the power storage sheet 1 is connected to the first terminal 3a, and each negative electrode side of the plurality of all-solid-state power storage element rows 31 is connected to the second terminal 3b.

As described above, in the power storage sheet 1, the first and second external electrodes 14, 15 are provided on the side surfaces of the all-solid-state power storage elements 10, and the side surfaces of the all-solid-state power storage elements 10 adjacent to each other are electrically connected to each other by the conductive member 21. For this reason, unlike the power storage device described in Patent Document 1, it is not always necessary to provide a sheet or a wiring for electrically connecting the all-solid-state power storage elements 10 to each other, in the thickness direction T with respect to the all-solid-state power storage elements 10. Thus, the power storage sheet 1 can be reduced in thickness. Accordingly, the capacity of the power storage sheet 1 per unit volume can be increased.

For example, a method of increasing the area in planar view, and then increasing the opposed area of a first internal electrode and a second internal electrode is conceivable as a method for increasing the capacity of a power storage sheet that uses an all-solid-state power storage element per unit volume. However, it is difficult to manufacture the all-solid-state power storage elements which have large-area electrodes because it is difficult to fire the elements. On the other hand, the power storage sheet 1 has a capacity increased by electrically connecting the plurality of all-solid-state power storage elements 10, and thus does not necessarily require an all-solid-state power storage element that has a large area in planar view. Therefore, the power storage sheet 1 is easy to manufacture.

From the viewpoint of further enhancing the ease of manufacturing the power storage sheet 1, the longest side of the all-solid-state power storage element 10 is preferably 1 mm or less, and more preferably 0.6 mm or less in length. However, if the all-solid-state power storage element 10 is excessively small, the volume ratio of the all-solid-state power storage element 10 to the power storage sheet 1 will be decreased. Thus, the longest side of the all-solid-state power storage element 10 is preferably 0.1 mm or more, and more preferably 0.4 mm or more in length.

In addition, in the power storage sheet 1, the rated capacity, the rated voltage, the rated current, and the like can be changed by changing the number of the all-solid-state power storage elements 10, the connection mode of the all-solid-state power storage elements 10 by the conductive members 21, and the like. Thus, the power storage sheet 1 has a high degree of freedom for design.

It is to be noted that an example in which all of the all-solid-state power storage elements 10 are connected between the first terminal 3a and the second terminal 3b has been described in the present embodiment. However, the present invention is not limited to this configuration. For example, an all-solid-state power storage element may be provided which is not connected between the first terminal and the second terminal. In addition, an electronic element other than all-solid-state power storage elements, a space, and the like may be provided in the power storage sheet.

An example in which the all-solid-state power storage element 10 has a cuboid shape has been described in the present embodiment. However, the present invention is not limited to this configuration. In the present invention, the all-solid-state power storage element may be, for example, polygonal in planar view, circular in planar view, elliptical in planar view, oval in planar view, or the like. Similarly, in the present invention, the shape of the power storage sheet is also not particularly limited. The power storage sheet may have, for example, a polygonal shape, a circular shape, an elliptical shape, an oval shape, or the like.

Further, in a case where the all-solid-state power storage element has a cuboid shape, it is not always necessary to provide the second external electrode on the side surface opposed to the side surface on which the first external electrode is provided. For example, the side surface on which the first external electrode is provided may be adjacent to the side surface on which the second external electrode is provided.

Other examples of preferred embodiments of the present invention will be described below. In the following description, members that have substantially the same functions as those in the first embodiment will be referred to with common reference numerals, and description thereof will be omitted.

### Second to Fourth Embodiments

In the present invention, the connection mode of the plurality of all-solid-state power storage elements 10 is not particularly limited. According to the present invention, for example, at least some of the plurality of all-solid-state power storage elements may be connected in series, at least some of the plurality of all-solid-state state power storage elements may be connected in parallel, or the plurality of all-solid-state power storage elements connected in parallel may be connected in series. In the following second to fourth embodiments, the connection mode of a plurality of all-solid-state power storage elements 10 will be illustrated by example.

FIG. 3 is a schematic plan view of a battery 2a according to the second embodiment. As shown in FIG. 3, in a power storage sheet 1a of the battery 2a, a plurality of all-solid-state power storage elements 10 arranged in the y-axis direction are connected in parallel by a conductive member 21 to form a plurality of all-solid-state power storage element columns 32. The plurality of all-solid-state power storage element columns 32 arranged in the x-axis direction are connected in series by a conductive member 21.

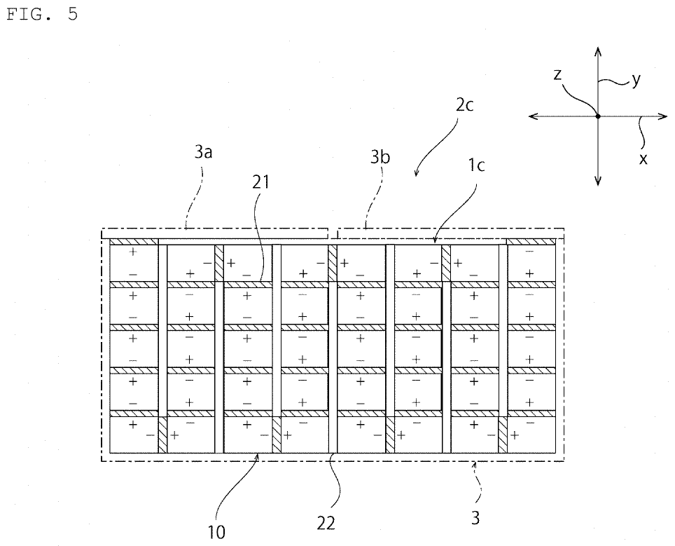

FIG. 4 is a schematic plan view of a battery 2b according to the third embodiment. In a power storage sheet 1b of the battery 2b, two all-solid-state power storage element units 33a, 33b are connected in series, where a plurality of all-solid-state power storage element rows 31a composed of a plurality of all-solid-state power storage elements 10 arranged in the x-axis direction, connected in series by a conductive member 21, are connected in parallel.

FIG. 5 is a schematic plan view of a battery 2c according to the fourth embodiment. In a power storage sheet 1c of the battery 2, all-solid-state power storage elements 10 are all connected in series. Thus, the power storage sheet 1c has a high rated voltage.

In addition, the battery 2c has both a first terminal 3a and a second terminal 3b provided on one side surface of an exterior body 3. Thus, it is easy to secure the electrical connection between the battery 2c and other electronic devices.

### Fifth Embodiment

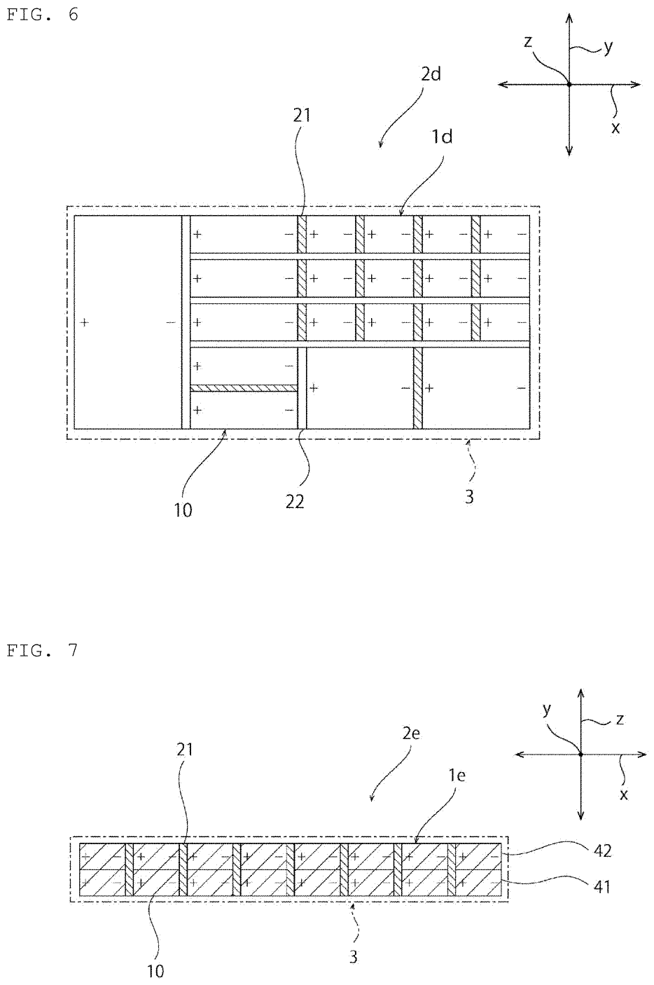

FIG. 6 is a schematic plan view of a battery 2d according to the fifth embodiment. Like a power storage sheet 1d of the battery 2d, a plurality of types of all-solid-state power storage elements 10 may be provided which differ in area in planar view from each other and differ in capacity from each other. In addition, a plurality of types of all-solid-state power storage elements may be provided which differ in area in planar view from each other, but has the same capacity. A plurality of types of all-solid-state power storage elements may be provided which differ in capacity from each other, but has the same area in planar view.

The power storage sheet 1d includes at least one all-solid-state power storage element 10, and includes a plurality of power storage parts electrically isolated from each other. The plurality of power storage parts include a plurality of power storage parts that differ in operating voltage from each other. Thus, the power storage sheet 1d can be used, for example, as a power supply for a plurality of electronic components that differ in operating voltage.

### Sixth Embodiment

FIG. 7 is a schematic plan view of a battery 2e according to the sixth embodiment. Like a power storage sheet 1e of the battery 2e, a plurality of all-solid-state power storage element layers 41, 42 may be stacked, which include a plurality of all-solid-state power storage elements 10 arranged in a matrix in one direction (x-axis direction) and another direction (y-axis direction) that is different from the one direction. Even in this case, the capacity per unit volume can be increased.

In a case where a plurality of all-solid-state power storage element layers are stacked as in power storage sheet 1e, all-solid-state power storage elements adjacent to each other in the stacking direction may be electrically connected to each other.

### DESCRIPTION OF REFERENCE SYMBOLS

1, 1a, 1b, 1c, 1d, 1e: power storage sheet
2, 2a, 2b, 2c, 2d, 2e: battery
3: exterior body
3a: first terminal
3b: second terminal
10: all-solid-state power storage element
11: all-solid-state power storage element body
11A: solid electrolyte layer
11a: first main surface
11b: second main surface
11c: first side surface
11d: second side surface
11e: third side surface
11f: fourth side surface
12: first internal electrode
13: second internal electrode
14: first external electrode
15: second external electrode
21: conductive member
22: fixing member
31, 31a: all-solid-state power storage element row
32: all-solid-state power storage element column
33a, 33b: all-solid-state power storage element unit
41, 42: all-solid-state power storage element layer

1. A power storage sheet comprising:
a plurality of all-solid-state power storage elements disposed in a same plane;
a first external electrode on a surface of the power storage sheet;
a second external electrode on the surface of the power storage sheet; and
a conductive member disposed between adjacent all-solid-state power storage elements of the plurality of all-solid-state power storage elements, and configured to fix and electrically connect the adjacent all-solid-state power storage elements of the plurality of all-solid-state power storage elements to each other.

2. The power storage sheet according to claim 1, wherein the plurality of all-solid-state power storage elements are a first plurality of all-solid-state power storage elements, and the power storage sheet further comprises a second plurality of all-solid-state power storage elements connected in parallel to the first plurality of all-solid-state power storage elements.

3. The power storage sheet according to claim 1, wherein the plurality of all-solid-state power storage elements are a first plurality of all-solid-state power storage elements, and the power storage sheet further comprises a second plurality of all-solid-state power storage elements connected in series to the first plurality of all-solid-state power storage elements.

4. The power storage sheet according to claim 1, wherein a longest side of the all-solid-state power storage element is 0.1 to 1 mm in length.

5. The power storage sheet according to claim 1, wherein the plurality of all-solid-state power storage elements includes a plurality of types of all-solid-state power storage elements that differ in capacity from each other.

6. The power storage sheet according to claim 1, wherein the plurality of all-solid-state power storage elements includes a plurality of types of all-solid-state power storage elements that differ in area from each other in a planar view of the power storage sheet.

7. The power storage sheet according to claim 1, comprising a plurality of stacked all-solid-state power storage element layers, each of the all-solid-state power storage element layers including a plurality of all-solid-state power storage elements arranged in a matrix in a first direction and a second direction that is different from the first direction.

8. The power storage sheet according to claim 1, further comprising a fixing member that fixes the adjacent all-solid-state power storage elements to each other that are not fixed by the conductive member.

9. The power storage sheet according to claim 1, wherein the fixing member is made of a non-conductive adhesive material or a cured product of a non-conductive adhesive material.

10. The power storage sheet according to claim 1, wherein the plurality of all-solid-state power storage elements are arranged in a matrix in a first direction and a second direction that is different from the first direction.

11. The power storage sheet according to claim 1, wherein the surface of the power storage sheet includes a first side surface and a second side surface opposite the first side surface, and wherein the first external electrode is on the first side surface and the second external electrode on the second side surface.

12. The power storage sheet according to claim 1, wherein the plurality of all-solid-state power storage elements are connected in series.

13. The power storage sheet according to claim 1, wherein the conductive member comprises a metal, a conductive adhesive material, or a cured product of a conductive adhesive material.

14. The power storage sheet according to claim 1, wherein at least some of the plurality of all-solid-state power storage elements are connected in series.

15. The power storage sheet according to claim 1, wherein at least some of the plurality of all-solid-state state power storage elements are connected in parallel.

16. The power storage sheet according to claim 1, wherein a first set of the plurality of all-solid-state power storage elements are connected in parallel and a second set of the plurality of all-solid-state power storage elements are connected in series.

17. A battery comprising:
the power storage sheet according to claim 1; and
an exterior body housing the power storage sheet.
